(19) United States
(12) Patent Application Publication
(10) Pub. No.: US 2007/0055925 A1
(43) Pub. Date: Mar. 8, 2007

(54) Themes for variable data printing

(76) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,782

(22) Filed: Jul. 26, 2006

(30) Foreign Application Priority Data
Sep. 8, 2005 (GB) 0518312.4

(51) Int. Cl. G06F 17/00

(52) U.S. Cl. 715/511; 715/517

(57) ABSTRACT

A method, system and a computer program product for generating a variable-data printing document template, from a variant/template comprising a layout of document portions, at least one of the document portions comprising a variable portion containing content which is variable, and a base template comprising a layout of document portions, at least one of the document portions comprising the variant. The document template defines multiple document versions, with each document version being selectable in response to input selection data. There is provided a way of production of variable-data publishing (VDP) documents for Digital Publishing (DP) that rely upon complex document designs containing dynamic themes at multiple levels of hierarchy. Such hierarchical use of themes makes it easier to obtain sophisticated document templates from more simple templates that can be managed at design time.

### FIELD OF THE INVENTION

This invention relates to a method, system and a computer program product for generating a document template, and to a variable-data printing document template which defines multiple document versions, each document version being selectable in response to input selection data.

### RELATED ART

The advent of digital technology means there are now more ways than ever to communicate. This increased ability to send and receive data significantly expands an organisation's ability to deliver information via the Internet and advanced printing and publishing systems.

The combination of Web technologies and digital printing can reduce communication costs, help businesses acquire new customers, increase the loyalty and buying habits of current customers, enable new revenue opportunities, and give birth to new business models.

By gathering the right data and utilizing digital publishing an organisation can deliver information customized to their customer's wishes, when they need it. Consequently, it is no surprise that personalized, highly targeted collateral and direct marketing are widely accepted as key factors in achieving higher response rates, increased efficiencies, and improved marketing.

Digital publishing solutions enable real-time targeted marketing (RTTM) by enabling the ability to create, print on demand, and distribute marketing collateral such as brochures, presentations, direct mail and point of sale materials that are customised to each audience member in a cost effective manner. However, the value of RTTM extends beyond improved marketing response rates by helping reduce costs and drive incremental revenue.

Variable-data printing (VDP) is a form of on-demand printing in which all the documents in a print run are similar but not identical. A mail merge is a simple form of VDP. For example, personalized letters may have the same basic layout, but there will be a different name and address on each letter.

Variable-data printing can now go far beyond printing different names and addresses on a document. There are systems that enable the user to insert different graphics into a document, change the layout and/or the number of pages, print a unique bar code on each document and more.

A prominent example of VDP usage is how credit-card companies analyze the buying histories of their customers and send information about specific products and services related to the ascertained customer interests. VDP systems are used to print these customized advertisements.

The concept of creating variable-data documents has also been extended to non-paper documents such as PDF documents and HTML documents. The term variable-data publishing (VDP) encompasses both paper documents and on-line documents.

Due to the resultant demands for the layout, content and personalisation of documents, high-volume print jobs are becoming more complex. In addition to this, pressure on the operators at the machines is increasing.

Personalized Print Markup Language (PPML) is the print industry's answer to these issues. PPML is a new, Extensible Markup Language (XML)-based, industry standard print language for variable data publishing (VDP). It enables high-speed, efficient printing and production of documents with reusable and variable content.

The PPML language uses XML, the Extensible Markup Language, as its syntactical base, giving it an affinity to many Web-based applications, and can access page content files generated in many different formats. Because PPML is independent of printer language, PPML can be used to create output that will support any printer language. Any PPML-compliant printer with the appropriate features will accept the same print file, no matter what software created it and what printer generates the output. Thus, applications will ultimately range from desktop to high-end digital printing presses.

The generation of VDP collateral material for Digital Publishing requires the generation of templates addressing the support for variable content and dynamic layout. Consequently, there now exists a version of PPML for variable data called PPML/T. The ‘T’ part of PPML/T corresponds to a template which is sent to the press where it can be merged with a database and a library of repeated elements to produce a PPML document.

It can be very difficult for the Graphic Artist (GA) to deal with the complexity and abstraction of a document template that represents multiple document versions. If the level of abstraction is high, and consists of aggregating completely different templates, the authoring process can be impossible or meaningless.

Current tools and techniques provide the designer with the possibility of previewing the final result using sample data, but this is a trial and error approach that is not optimal.

Thus, it is desirable to reduce the complexity of document abstraction from the design phase. The GA may then design a document template that incorporates multiple layouts, all of which can accommodate variable content that is defined by external data, with a more “What-You-See-Is-What-You-Get” (WYSIWYG) design approach.

### SUMMARY OF THE INVENTION

According to a first aspect of the invention, there is provided a method of generating a variable-data printing document template in a computer readable format, the template defining multiple document versions, with each document version being selectable in response to input selection data, the method comprising:
defining a variant comprising a layout of document portions, at least one of the document portions comprising a variable portion containing content which is variable;
defining a base template comprising a layout of document portions, at least one of the document portions comprising the variant; and
defining a plurality of document versions, each document version comprising a unique combination of document portions, and indicating the desired variable content of the variable portion.

According to another aspect of the invention, there is provided a method of generating a document for printing, the document comprising one version of a variable-data printing document template which defines multiple document versions and in which each document version is selectable in response to input selection data, the method comprising:
generating the document template, by:
   defining a variant comprising a layout of document portions, at least one of the document portions comprising a variable portion containing content which is variable;
   defining a base template comprising a layout of document portions, at least one of the document portions comprising the variant;
   defining a plurality of document versions, each document version comprising a unique combination of document portions, and indicating the desired variable content of the variable portion; and
   merging the variant and base template to generate a document template which defines multiple document versions, each document version being selectable in response to input selection data; and
generating a document for printing by providing input selection data to the document template which defines the document version.

According to yet another aspect of the invention, there is provided a system for generating a variable-data printing document template, the template defining multiple document versions, with each document version being selectable in response to input selection data, the system comprising:
a processor which is adapted to:
   receive from a user a variant definition comprising a layout of document portions, at least one of the document portions comprising a variable portion containing content which is variable;
   receive from a user a base template definition comprising a layout of document portions, at least one of the document portions comprising the variant; and
   receive from a user data defining a plurality of document versions, each document version comprising a unique combination of document portions, and indicating the desired variable content of the variable portion; and
   provide to a printer a document template.

According to further aspect of the invention there is provided a computer program for implementing a method of generating a variable-data printing document template, the program adapted to carry out the steps of:
receiving user definitions defining a variant comprising a layout of document portions, at least one of the document portions comprising a variable portion containing content which is variable;
receiving user definitions defining a base template comprising a layout of document portions, at least one of the document portions comprising the variant, and further defining a plurality of document versions, each document version comprising a unique combination of document portions, and indicating the desired variable content of the variable portion;
generating a computer readable variable data printing document template in response to the user definitions.

### BRIEF DESCRIPTION OF THE DRAWINGS

For a better understanding of the invention, embodiments will now be described, purely by way of example, with reference to the accompanying drawings, in which:

FIG. 1 shows an overview of a system proposed by the applicant for printing variable-data publishing documents from a template, the template defining multiple document versions, with each document version being selectable in response to input selection data;

FIG. 2 shows the process of generating documents using the system of FIG. 1 for printing from a template, the template defining multiple document versions, with each document version being selectable in response to input selection data;

FIG. 3 shows the concept proposed by the applicant of a document template defining multiple document versions, the template comprising a layout of document portions, at least one of the document portions comprising a variable portion containing content which is variable;

FIG. 4 shows the concept of a template defining multiple document versions, the template comprising a layout of document portions, at least one of the document portions comprising a variant;

FIG. 5 shows the process of generating a document template from a plurality of templates and variants;

FIG. 6 illustrates the different levels of theme hierarchy and the associated levels of abstraction and granularity; and

FIG. 7 is a flow diagram illustrating a method of generating a document for printing according to an embodiment of the invention.

### DETAILED DESCRIPTION OF THE INVENTION

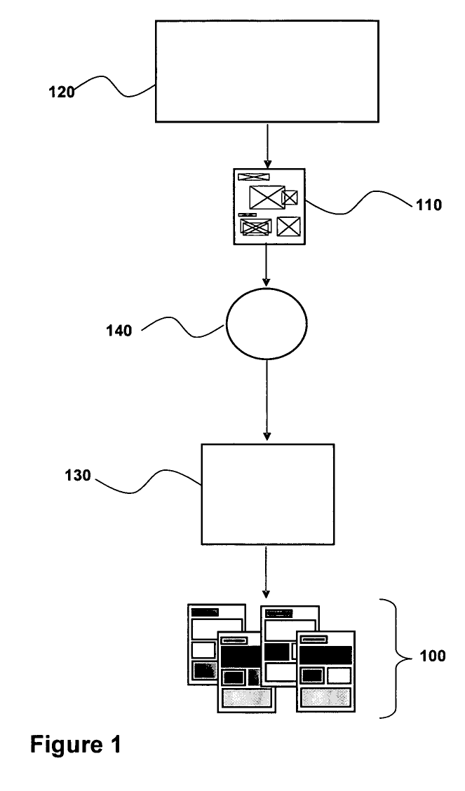

FIG. 1 shows an overview of a system proposed by the applicant for printing VDP documents 100 from a template 110, the template defining multiple document versions, with each document version being selectable in response to input selection data.

The system comprises a producer 120 and a consumer 130. The producer 120 produces VDP templates and documents for publishing by the consumer 130, the templates and documents most commonly being in PPML format. Typically, the producer 120 uses a computer based design system or graphic tool with which the document template 110 is designed.

Once the VDP template 110 is finalised, the template 110 is passed to the consumer 130, often via a marketing manager 140. In response to data provided by the marketing manager 140, the consumer 130 publishes documents 100 defined by the template 110. The consumer 130 provides means of publishing documents 100 such as a printer or digital press.

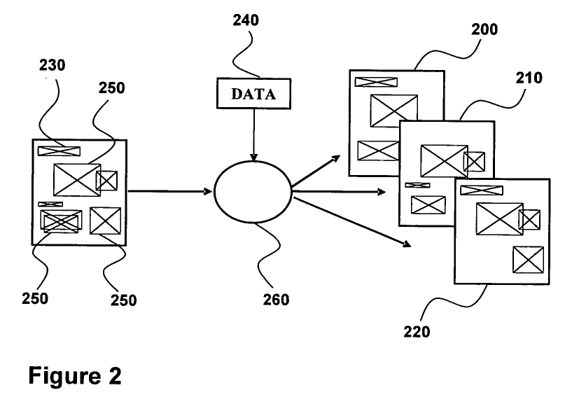

Referring to FIG. 2, the process of generating documents 200,210,220 for printing from a document template 230 which defines a document containing variable content in response to input data 240 is shown. The document template 230 comprises a layout of copy-holes 250 containing content which is variable in response to the input data 240.

The document template 230 includes the concept of a dynamic theme. A Theme is a concept that enables different versions of a document to be generated, for example documents in different languages. A dynamic theme provides the possibility of expressing a copy-hole 250 as part of a set of options, one of which being non-existence of the copy-hole 250. For example, a dynamic theme can enable copy-holes to appear and disappear based upon rules and applied data 240.

The document template 230 is passed to a processor 260 to be merged with input data 240. The input data 240 may be a form of collated data such as, purely by way of an example, a table, a database or a spreadsheet, which defines each document version and the content to be merged into the copy-hole 250 of the document template 230 by the processor 260. The processor 260 merges data 240 with the document template 230 and renders the result to produce a document 200 comprising content in response to the data 240.

From a single document template 230, the processor 260 is able to merge the input data 240 to create a plurality of documents 200,210,220 which all contain unique layouts and content.

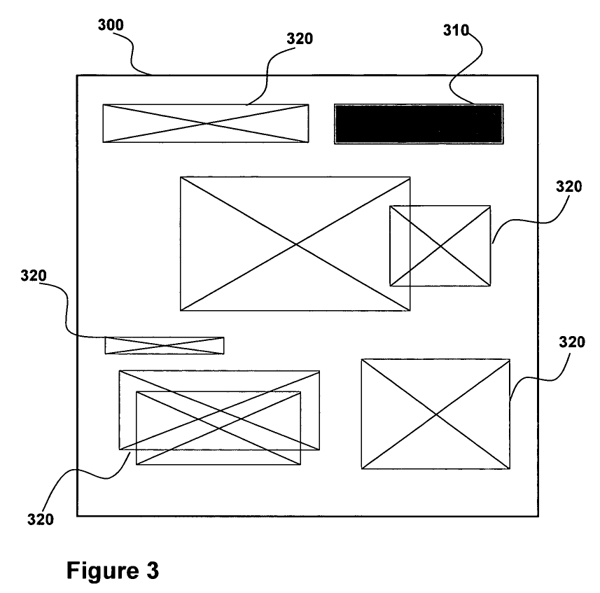

Referring to FIG. 3, complex document designs can consist of a document template 300 comprising a section of fixed content 310 and copy-holes 320. A copy-hole 320 is a document portion comprising content which is variable.

As mentioned above, the copy-hole 320 is expressed as part of a set of options, one of which being the non-existence of the copy-hole. This provides a document template 300 that allows a Graphic Artist (GA) to design the layout of the fixed content 310 and the copy-holes 300 in a single template 300.

The GA can also control the positioning, size and content of the copy-holes 320 similarly to all the other parts of the design. Thus, the GA may predict, at design time, the final document instance appearance. The template 300 shows all the copy-holes 320 so that the GA can position, re-size and accommodate them.

Once all of the copy holes 320 have been created and correctly positioned, the GA registers them as part of the Dynamic Theme. Themes are supported using a special paradigm in a Personalized Print Markup Language Template (PPML/T).

For example, the selection between the existence and non-existence of a document page may be implemented using a <xsl:choose> construct expressed as follows:

```
<xsl:choose>
  <xsl:when test=“(Condition = ‘True’)”
    <ppml:PAGE id=“02”>
    ...
    </ppml:PAGE>
  </xsl:when>
</xsl:choose>
```

The above example defines a document page with an identity of “02” when a predetermined condition is satisfied. The <xsl:when> test is therefore used to establish whether the page should be included or not. If the condition is not satisfied, the page is simply not defined. Thus, the <xsl:choose> construct simply selects different theme options in response to external data.

The program code uses standard XSL tags as defined by the World Wide Web Consortium (W3C). These will be known to those skilled in the art and accordingly are not described in detail.

By registering copy-holes to themes, the GA can create a document template 300 that incorporates multiple layouts, all of which can accommodate variable content that is defined by external data.

Rules that trigger the various options in the template can then be formulated, the rules enabling particular options of the theme, for example enabling particular copy-holes and disabling others. These theme options can be described at design time and saved in a section of the PPML/T template 300.

Since the theme options are defined at design-time, there is no need for the GA to bind real data with the theme options in order to produce a final document for exporting to print.

The above approach exploits the separation between the document template 300 and the external data. The GA can create a document template 300 that incorporates multiple layouts, all of which can accommodate variable content that is defined by external data and theme rules.

Furthermore, it can be possible for the GA to temporarily enable or disable some of the copy-holes, thus providing means of visualizing particular document layouts at design time without binding external data to the template to create a final document. The operation of merging data with the document template, to create documents with variable content in response to the data, can then be executed at post-design time.

The applicant has thus proposed a way of providing basic dynamism to a design template, agglomerating into a single template many variants that would otherwise require different templates. The advantage is in the reduction of the number of required templates and the resultant alleviation of problems associated with multiple updates.

However, in the case that the template 300 has a considerable number of copy-holes 320, embedding all of the copy-holes 320 into a single template can become difficult for the GA to represent, adding more and more abstraction at the template generation stage. This has a detrimental effect on the design process, since the GA is not easily able to make a good design when the document template is an abstraction and there is minimal static content.

One possibility is to layer copy-holes 320, and “temporarily” switch off particular copy-holes 320 so that the GA can concentrate on a particular layout of copy-holes 320. However, it remains very difficult for the GA to deal with the complexity and abstraction of the document template.

The invention extends the concept explained above of dynamic themes to all the possible levels in the PPML-PPML/T document structure. The hierarchical use of themes provides the possibility of expressing a document template at different levels of abstraction so that the designer can express high variability in templates as well as a high degree of control on the contents of a copy-hole (a document portion comprising content which is variable).

Accordingly, the invention enhances the production of variable-data publishing (VDP) documents for Digital Publishing (DP) that rely upon complex document designs containing dynamic themes at multiple hierarchies. Such hierarchical use of themes makes it easier to obtain sophisticated document templates from more simple templates that can be managed at design time.

This approach enables the high-level creation of a template starting from an existing set of templates that may, or may not, share common variables. It also enables the low-level design of a single variable with variation in its source, such as size or Multipurpose Internet Mail Extensions (MIME) type. (MIME is an Internet standard for describing message content types. MIME messages can contain text, images, audio, video, and other application-specific data).

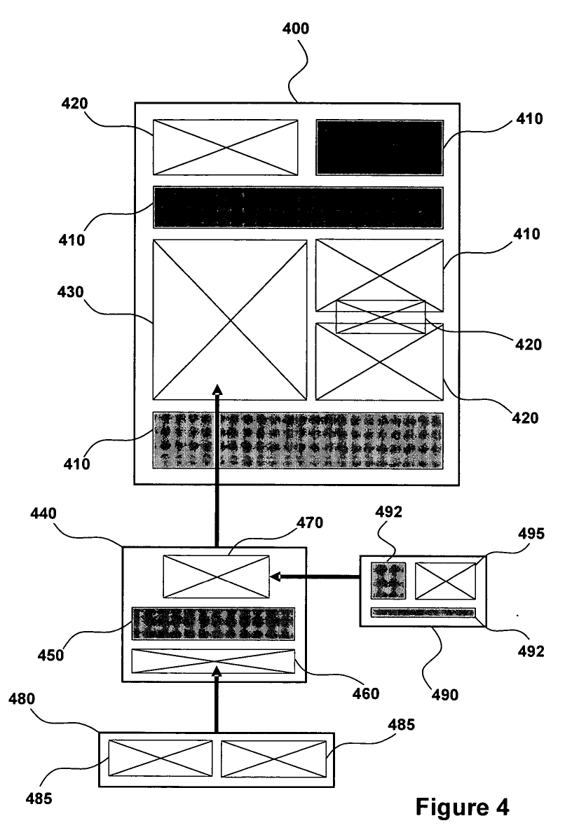

Referring to FIG. 4, a document base template 400 comprises sections of fixed content 410 and variants 420,430. Variant 430 is registered as part of a theme and supports a separate document template 440, the separate document template 440 comprising a section of fixed content 450 and variants 460, 470 that are registered as part of another theme. As explained above, Themes are supported using a special paradigm in a Personalized Print Markup Language Template (PPML/T). By registering variant 430 to a theme, the GA can create a document template 400 that incorporates multiple layouts, all of which can accommodate variable content that is defined by external data and are selected using the <xsl:choose> construct as detailed above.

Variant 430, therefore, supports a nested template variant 440 that has a lower level of abstraction and higher level of granularity when compared to the parent 400. Variants 460, 470 are also nested variants that have a lower level of abstraction and higher level of granularity when compared to their parent variant 440.

Variant 460 supports a separate document template 480 comprising a plurality of copy-holes 485 that are registered as part of a Dynamic Theme. By registering copy-holes 485 to a theme, the GA can create a document variant 480 that incorporates multiple layouts, all of which can accommodate variable content that is defined by external data.

Variant 470 supports a separate document template 490 which comprises fixed content 492 and variable source content 495. The variable source content 495 is defined such that the source of the content, for example its size or Multipurpose Internet Mail Extensions (MIME) type, is variable and defined by external data.

Thus, document template 400 defines multiple document versions, the template 400 comprising a layout of document portions 410,420,430, one of the document portions 430 supporting a further document template 440 that, in turn, also supports further document templates 480,490 that define multiple document versions in response to external data.

Because themes are supported using a special paradigm in PPML/T, such a base template 400 may be provided in a computer readable format and its multiple layouts, all of which can accommodate variable content that is defined by external data, can then be selected using the <xsl:choose> construct as explained above.

The input data can be represented using Extensible Markup Language (XML). Since XML is a cross-platform, software and hardware independent tool for transmitting information, data represented as XML can be exchanged between incompatible systems. Accordingly, use of XML can greatly reduce the complexity of exchanging the data.

This, example of the invention thus provides a document template 400 that enables a GA to design complex document layouts at multiple levels of abstraction.

The GA can control the layout of the base template 400, controlling the positioning, size and content of the copy holes 410,420,430 similarly to all the other parts of the design. Further, the GA can control the layout of the document templates 440,480,490 nested within the base template 400. This can be done separately, designing the nested document template 440 as a standalone template, which in turn contains sections of fixed content 450 and variants 460, 470. The separate standalone design process can then be completed for the variants 460,470 of the document template 440, enabling complete control of the layout and content.

The combined use of the <xsl:choose> construct at different levels enables the designer to express high variability in templates, as well as a high degree of control on the variant's content. When the theme concept is expressed to the higher elements in the document structure, the designer will consider a higher level of abstraction. When the theme concept is applied to the lower elements, the designer will be able to increase the level of granularity on the document variant.

The complexity of dealing with abstraction is left to a post-design phase, allowing the GA to take a more WYSIWYG approach in designing document templates. The designer can concentrate on designing a set of document instances and then a document engineer completes the process of abstracting the document instances into a document template without violating the design principle imposed by the designer in the different documents.

Example of the invention supports the presence of document templates 480,490 within a nested document template 440. Consequently, an indefinite number of nesting levels may be supported while still providing a base document template 400 that is structured and suitable for producing multiple document versions.

The introduction of hierarchical themes as a concept opens up the possibility of supporting document variants without adding complexity at the design stage. The designer can simply design the “base” version of the template and then adjust this version to add variants that support further templates, document insets, different positioning and even more complicated situations.

It is possible to have two completely separate layouts and merge them at post-design, defining a template and data schema theme to drive the selection through variable data and applied rules.

Because the invention provides for a single template representation, the Marketing Manager can write a single rule that can span over several templates.

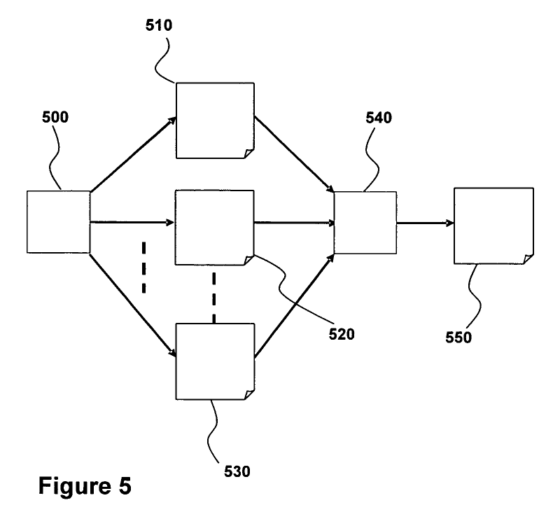

FIG. 5 shows the concept of designing a base template 500 comprising a layout of sub-templates, exporting it in a computer readable format as a PPML/T document 510 and sub-templates identified as variants 520,530. Once the base and variant documents are generated, a post-design tool 540 will import them, trace the changes and produce a resulting PPM/T file 550 with a hierarchical theme structure.

The themes paradigm can be used at different levels in the Content-PPML-PPML/T hierarchy inside the document structure. For example, a first <xsl:choose> construct, within the base template, may be used to choose between the existence of two sub-templates, while further <xsl:choose> constructs, within the sub-templates, may be used to select the size of an image in the sub-template.

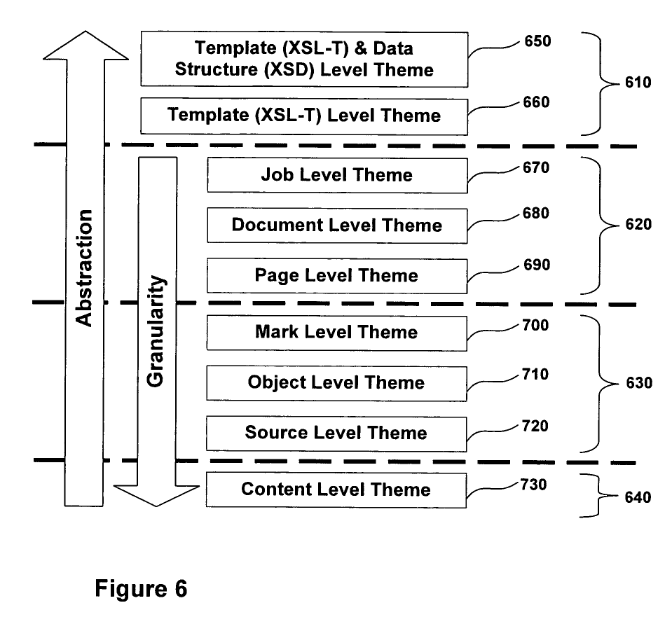

FIG. 6 shows the levels of theme hierarchy and the associated levels of abstraction and granularity. The hierarchy can be sub-divided into four main areas, using a top-down approach: Inter-Template Variants 610; Intra-Template Variants 620; Intra-Page Variants 630; and Content Variants 640.

Inter-Template Variants 610 provide the highest level of abstraction, providing for the realization of documents based on the aggregation of whole templates. In comparison, a lower level of abstraction is provided by Intra-Template Variants 620, such variants of a template being actual documents. Intra-Page Variants 630 provide a further reduction in the level of abstraction, having variability in their existence, positioning, and reproduction within a document. Finally, Content Variants 640 provide the lowest level of abstraction, and highest level of granularity, by simply enabling changes in the actual content. For completeness, the four main areas of hierarchy will now be detailed further.

Inter-Template Variants 610

At this level in the hierarchy, it is possible to aggregate completely different templates inside the same PPML/T document. There are two sub-cases that may be considered at this level: Template and Data Structure Level Themes 650; and Template Only Level Themes 660.

Template and Data Structure Level Themes 650 enable the aggregation of completely different templates that may have completely different variables and require different data-mappers. This is equivalent to combining two complete PPML/T documents, enabling the possibility of merging templates that are completely different.

Template Only Level Themes 660 enable the aggregation of data-related templates where the different templates share the data and the data-mapping. This enables the possibility of merging templates that can be completely different in layout, but share the same variable data model.

Intra-Template Variants 620

At this level in the hierarchy, it is possible to aggregate, inside the PPML/T, documents belonging to the same family, but with relevant differences. There exist three sub-cases at this level: Job or Document Set Level Themes 670; Document Level Themes 680; and Page Level Themes 690.

Job or Document Set Level Themes 670 enable the definition of variants at the document level considering a change in the needed resources, for example the templates can have their own differences in resources such as fonts. In this case it is necessary for the templates to share the same variables and data mapper.

Document Level Themes 680 enable changes in the overall layout of the document, providing the possibility of merging templates that are different in overall layout and number of pages. Again, for this theme level, it is necessary for the templates to share the same variables and data mapper.

Page Level Themes 690 enable the change in the number of pages and/or the insertion of an extra page. It may also enable a different page size/orientation. However, is does not provide the possibility of having a content driven dynamic number of pages.

Intra-Page Variants 630

At this level of the hierarchy, it is possible to specialize page level variants that will affect both the existence and the positioning of the document inserts. Again, it is possible to identify three sub-cases: Mark Level Themes 700; Object Level Themes 710; Source Level Themes 720.

Mark Level Themes 700 are equivalent to the existing concept of Dynamic Themes as described earlier. Here, it is possible to add/remove and re-position copy-holes within the document. The copy-holes may also be grouped to achieve a more complex document layout.

Object Level Themes 710 enable the possibility of introducing a different relative positioning for the object within a copy-hole, which can be used in conjunction with the source level to accommodate variants of differing size. However, this will not affect neighbouring objects, nor will it support dynamic and/or content driven layouts.

Source Level Themes 720 are at the final level before content. Using this level, it is possible to change the source of the content, for example its size or MIME type. This approach is similar to that of using variable images in a template that supports different mime types. However, because it does not take into account any neighbouring object, it is preferred that this is used for small resultant variations.

Typically, document templates have a common part and a specialized part. The common part represents the uniform set of content and design that spans across the entire document family. This can be very predominant or quite loose.

If the base template is predominant, it is more likely that the variants will be more at the intra-page level and the GA may be designing document families with a very similar layout. This is because the generic layout, page sizes and number of pages are likely to be fixed.

In the case of a predominant base template, the variants may be represented by document insets and/or the re-positioning of some elements according to specific variable data.

If the base template is loosely predominant, the variants will be at the level above the page. This introduces a level of complexity that could not previously be achieved by forcing all of the templates to be accommodated under a single design. With existing systems, it is impossible to consider two templates with a different page orientation and/or page size as part of the same design.

Other possibilities are linked to the language variants, where the amount of content and/or the content alternatives are significantly different and may require a completely different data model.

The example of the invention described enables the designer to use the base template and, on top of it, add and modify the layout to accommodate the required changes. In this way, the GA does not need to change their approach and view the design in an abstract 3D/layered view, thus making the design process easier.

The GA can begin with a high-level creation of a base template starting from an existing set of templates that may, or may not, share common variables. The GA can then also focus on the design of the templates in isolation, which can in turn be made up of further variants that may also be designed in isolation. As a result, the low-level design of a single variable with variation in its source (source level theme), such as size or mime type, through to the high-level design of a template comprising a plurality of variable templates (template level theme) can be handled by the GA with a more WYSIWYG design approach.

Thus, it is to be appreciated that embodiments of the invention provide a method for generating a variable-data printing document template, the template defining multiple document versions, with each document version being selectable in response to input selection data. In addition, alternative embodiments provide a method of generating a document for printing, the document comprising one version of a variable-data printing document template.

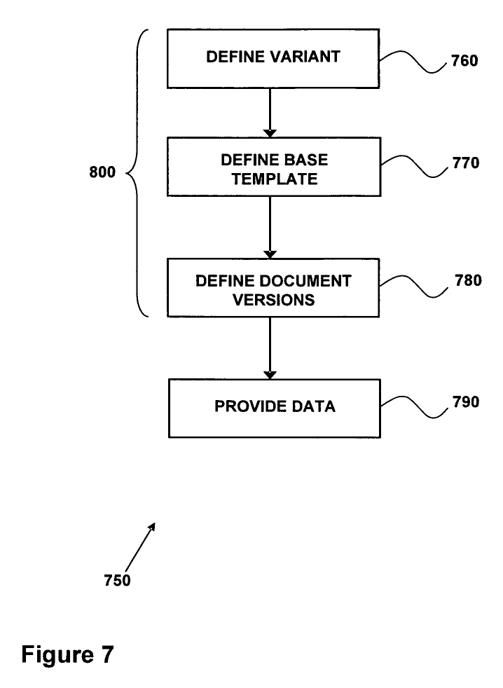

Referring now to FIG. 7, a flow diagram is shown that illustrates a method of generating a document for printing according to an embodiment of the invention. The document comprises one version of a variable-data printing document template which defines multiple document versions, each document version being selectable in response to input selection data. The method is indicated generally by arrow 750 and comprises method steps 760 to 790.

Step 760 comprises defining a variant comprising a layout of document portions, at least one of the document portions comprising a variable portion containing content which is variable.

In step 770, a base template comprising a layout of document portions is defined, wherein at least one of the document portions comprises the variant defined in step 760.

In step 780, a plurality of document versions is defined and the desired variable content of the variable portion is indicated. Each document version defined comprises a unique combination of document portions.

In step 790, a document for printing is generated by providing input selection data to the document template which defines the document version.

It may also be appreciated that a method for generating a variable-data printing document template, indicated generally by 800, is provided by steps 760, 770 and 780 of FIG. 7. In response to the input selection data which defines the document version, a document may therefore be generated from a template provided by method 800.

Embodiments of the invention may be implemented as a GA tool to represent documents composed by computer based design software such as Quark xPress and Adobe InDesign. Further modification may also enable the invention to be incorporated into existing VDP software and systems.

Those skilled in the art will realise that the above embodiments are purely by way of example and that modification and alterations are numerous and may be made while retaining the teachings of the invention.

We claim

1. A method of generating a variable-data printing document template in a computer readable format, the template defining multiple document versions, with each document version being selectable in response to input selection data, the method comprising:
defining a variant comprising a layout of document portions, at least one of the document portions comprising a variable portion containing content which is variable;
defining a base template comprising a layout of document portions, at least one of the document portions comprising the variant; and
defining a plurality of document versions, each document version comprising a unique combination of document portions, and indicating the desired variable content of the variable portion.

2. A method as claimed in claim 1 wherein the different templates are designed separately and merged at post-design.

3. A method as claimed in claim 1 wherein the templates are merged to produce a document template with a hierarchical theme structure.

4. A method as claimed in claim 1 wherein the templates are associated with different data.

5. A method as claimed in claim 1 wherein the generation from the variable-data printing document template in response to the input selection data is based upon rules that define the document version.

6. A method as claimed in claim 1 wherein the variable-data printing document template is represented as a Personalized Print Markup Language Template (PPML/T).

7. A method as claimed in claim 1 wherein the input selection data comprises data represented as Extensible Markup Language (XML).

8. A method as claimed in claim 1 wherein the templates are associated with the same data.

9. A method as claimed in claim 1 wherein the templates have different resources.

10. A method as claimed in claim 1 wherein the templates have a different number of pages.

11. A method as claimed in claim 1 wherein the relative positioning of the contents of the variant is variable in response to input data.

12. A method as claimed in claim 1 wherein the source of the content is variable in response to input data.

13. A method of generating a document for printing, the document comprising one version of a variable-data printing document template which defines multiple document versions and in which each document version is selectable in response to input selection data, the method comprising:
generating the document template, by:
defining a variant comprising a layout of document portions, at least one of the document portions comprising a variable portion containing content which is variable;
defining a base template comprising a layout of document portions, at least one of the document portions comprising the variant;
defining a plurality of document versions, each document version comprising a unique combination of document portions, and indicating the desired variable content of the variable portion; and
merging the variant and base template to generate a document template which defines multiple document versions, each document version being selectable in response to input selection data; and
generating a document for printing by providing input selection data to the document template which defines the document version.

14. A method as claimed in claim 13 further comprising:
defining rules that depict the document version in response to the input selection data.

15. A method as claimed in claim 13 wherein the variable data printing document template is represented as a Personalized Print Markup Language Template (PPML/T).

16. A method as claimed in claim 13 wherein the variant is represented as a Personalized Print Markup Language Template (PPML/T).

17. A method as claimed in claim 13 wherein the variant is represented as Personalized Print Markup Language (PPML).

18. A method as claimed in claim 13 wherein the input selection comprises data represented as Extensible Markup Language (XML).

19. A method as claimed in claim 13 wherein the base template and variant are associated with the same data.

20. A method as claimed in claim 13 wherein the base template and variant have different resources.

21. A method as claimed in claim 13 wherein the base template and variant have a different number of pages.

22. A method as claimed in claim 13 wherein the relative positioning of the contents of the variant is variable in response to input data.

23. A method as claimed in claim 13 wherein the source of the content is variable in response to input data.

24. A system for generating a variable-data printing document template, the template defining multiple document versions, with each document version being selectable in response to input selection data, the system comprising:
a processor which is adapted to:
receive from a user a variant definition comprising a layout of document portions, at least one of the document portions comprising a variable portion containing content which is variable;
receive from a user a base template definition comprising a layout of document portions, at least one of the document portions comprising the variant; and
receive from a user data defining a plurality of document versions, each document version a unique combination of document portions, and indicating the desired variable content of the variable portion; and
provide to a printer a document template.

25. A system as claimed in claim 24, further comprising a printer, which is adapted to receive input selection data which defines a document version, and generate from the input selection data and the document template a document version.

26. A computer program for implementing a method of generating a variable-data printing document template, the program adapted to carry out the steps of:
receiving user definitions defining a variant comprising a layout of document portions, at least one of the document portions comprising a variable portion containing content which is variable;
receiving user definitions defining a base template comprising a layout of document portions, at least one of the document portions comprising the variant, and further comprising a plurality of document versions, each document version defining a unique combination of document portions, and indicating the desired variable content of the variable portion;
generating a computer readable variable data printing document template in response to the user definitions.

27. A computer program according to claim 26 wherein the computer readable variable data printing document template is represented as a Personalized Print Markup Language Template (PPML/T).

28. A computer program according to claim 26 further adapted to generate a document from the variable data printing document template in response to input data which defines the document content.
